(19) United States
(12) Patent Application Publication
(10) Pub. No.: US 2012/0233649 A1
(43) Pub. Date: Sep. 13, 2012

(54) Feeder Cam

(76) Inventor: Benjamin Henry Seigler, Sevierville, TN (US)

(21) Appl. No.: 13/044,199

(22) Filed: Mar. 9, 2011

(51) Int. Cl. A01K 5/00; H04W 84/02; H04N 7/173

(52) U.S. Cl. 725/109; 119/51.01; 370/338

(57) ABSTRACT

A Game Or Livestock Or Other Farm/Wildlife Animal Feeder With DVR's/Cameras/Routers/Batteries/Solar Panels In Which Live And Recorded Video Can Be Transmitted By Aircard/Satellite/Or Other Wireless Connection To Be Viewed Via Internet Or Smart Phone. Cameras/Components Hidden And Or Exposed To Be Used With Or Without External Power. Able To View Live Or Recorded Video/Pictures/Audio From Other Location As Well As Locally Router To Allow WiFi Service To Devices Within Range. Multiple Users Simultaneously. Can Be For Entertainment, Hunting, Surveillance, Security, Weather, Spying, Anti-Terrorist , Activity, Nature Observing, Climate, Monitoring, Construction Activities, Poaching, ETC.

### FEEDER CAM BRIEF DESCRIPTION OF DRAWING

FIG. 1

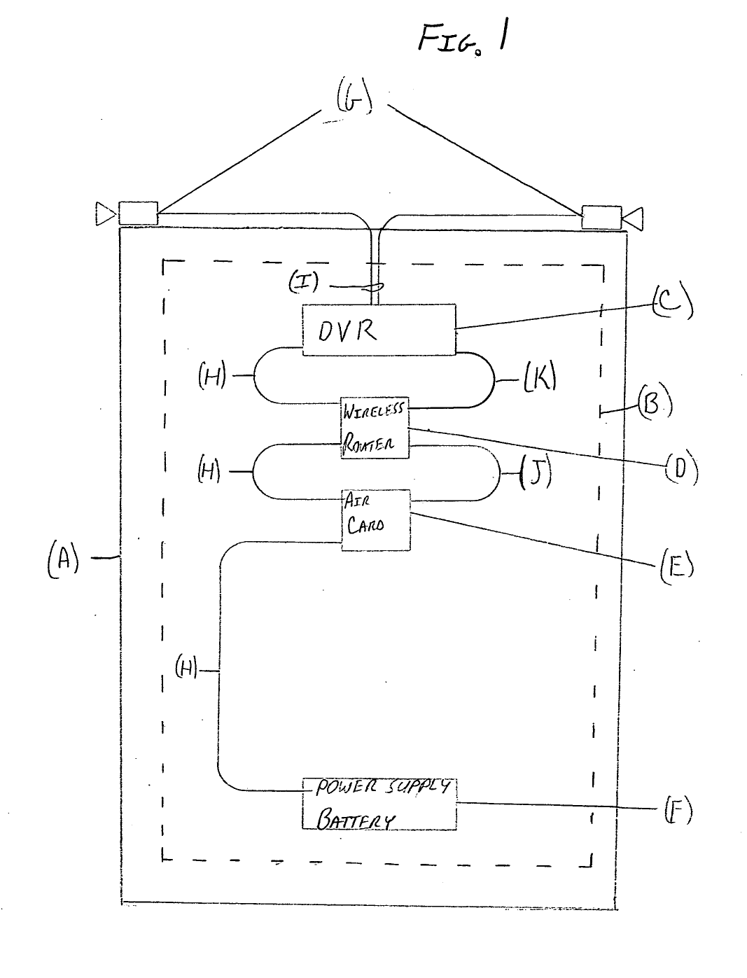

(A). Feeder Housing. Any Feeder container.

(B). Weatherproof/Waterproof Box located within or on a feeder container.

(C). DVR for security or surveillance cameras with internet capabilities.

(D). Wireless Router with Aircard capability.

(E). Aircard with service through local cellular/satellite service provider.

(F). Batteries or power supply.

(G).Cameras located in, on, or around the feeder.

(H). Conductors to provide power to electronic components.

(I). Conductors to provide power and video transmission to Cameras.

(J). Conductors to provide communication with Router and Aircard.

(K). Conductors to communicate Router with DVR.

(A). Represents a Feeder housing in which a (B) Weatherproof enclosure is installed either on or within the Feeder. The (B) enclosure will house the components C, D, E, H, I, J.

(C),Is a DVR used for camera security/surveillance systems.

(D). Is a Wireless Router that allows Internet access with the use of an

(E) Cellular Data Aircard . Service for Aircard is through a local Wireless provider.

(G). Cameras place in, on or around the feeder.

(H). Conductors to carry power to the electronic components.

(I). Conductors to carry audio, video, and power to and from the cameras.

(J). Conductors to carry data to and from the aircard and Wireless Router.

(K). Conductors to carry data to and from the Wireless Router and the DVR.

(F). Power supply and or Batteries to provide power for the Feeder Cam system.

1. Game or Livestock Feeder with Recording Cameras, in/on Structure Accessible by Internet Connection.

2. Game or Livestock Feeder with Live Streaming Video Accessible By Internet Connection.

3. Game or Livestock Feeder Transmitting Wi-Fi to Devices in Range.
